(19) United States
(12) Patent Application Publication
(10) Pub. No.: US 2006/0091615 A1
(43) Pub. Date: May 4, 2006

(54) Metal gasket

(75) Inventor: Tsunekazu Udagawa, Utsunomiya-shi (JP)

Correspondence Address: KANESAKA BERNER AND PARTNERS LLP, SUITE 300, 1700 DIAGONAL RD, ALEXANDRIA, VA, 22314-2848, US

(73) Assignee: ISHIKAWA GASKET CO., LTD, Tokyo (JP)

(21) Appl. No.: 11/264,094

(22) Filed: Nov. 2, 2005

(30) Foreign Application Priority Data
Nov. 4, 2004 (JP) 2004-320399

(51) Int. Cl. F02F 11/00

(52) U.S. Cl. 277/594

(57) ABSTRACT

A metal gasket is used for an internal combustion engine having a cylinder head with inlet and exhaust portions, and a cylinder block with a cylinder bore. The metal gasket is formed of at least one metal plate. The metal plate has a hole corresponding to the cylinder bore, at least one bead surrounding the hole, at least one sealing area under at least one of the inlet and exhaust portions, and at least one meandering bead located at the at least one sealing area to increase a surface pressure thereat. The sealing area can be increased in the surface pressure by the meandering bead.

### BACKGROUND OF THE INVENTION AND RELATED ART STATEMENT

The present invention relates to a metal gasket located between two engine members, such as a cylinder head and a cylinder block of an engine, to seal the area there between.

The cylinder head gasket is tightened by a head bolt once the cylinder head gasket is installed between the cylinder head and the cylinder block (cylinder body) of an automobile engine (internal combustion). The cylinder head gasket serves to seal fluids such as combustion gas, oil, coolant water, and so on.

Recently, due to the emphasis on reduction in weight of automobile engines, engine parts are often made lighter by being constructed of, for example, aluminum alloys. As the engine is lighter in weight, such engine parts has a lower rigidity (i.e., a lower resistance to being mechanically deformed). As a result, such parts are easily mechanically deformed, and maintenance of the sealing performance of the head gasket is increasingly difficult. In particular, the ability of the cylinder head gasket to seal gas from around the cylinder bore has become a major problem.

Specifically, with the low rigidity of the engine parts, when the cylinder head gasket is tightened, the unevenness of sealing surface pressure around the cylinder bore increases. As a result, the difference between portions at which the surface pressure is high, and portions at which the surface pressure is low, increases. Accordingly, this causes a disproportionate amount of gas leakage from the portion where the surface pressure is low.

In conventional technology, the aforementioned type of gas leak was addressed by increasing the total surface pressure of the sealing portion around the cylinder bore (combustion chamber), or by using a sealing bead material with an elastic capability in order to counteract partially decreased surface pressure due to flexure and so on.

However, when the total surface pressure is raised, or when the elastic capability of the entire bead is increased due to partially decreased surface pressure, an unnecessary impact arises even on those portions of the seal where the surface-pressure is sufficient and the sealing performance is normal.

When the inventor of the present invention analyzed the. aforementioned type of gas leak, it was found that the leak occurred primarily on the portion near the lower portion of a cylinder head. exhaust port or near the lower portion of a cylinder head inlet port. In the cylinder head, the exhaust port and inlet port penetrate or pass near a contact face of the gasket, so that the portion in the cylinder head becomes hollow. The areas near the centers of the exhaust port and the inlet port are structurally thin, so that lower surfaces of the exhaust port and inlet port are susceptible to bending when the gasket is tightened. Accordingly, the surface pressure of the sealing portion of the gasket near these locations is decreased, and this causes the gas leak.

In addition, technology by which the sealing performance around the cylinder bore or the other sealing holes of the metal gasket is improved by a waveform bead (i.e., a bead that is wave-like in shape) is well-known. See, for example, Japanese Patent No. 3057445.

The present invention has been developed to solve the aforementioned problems associated with conventional metal gaskets. An object of the invention, therefore, is to provide a metal gasket capable of providing excellent sealing performance relative to the cylinder bore, yet without causing any detrimental effect on other portions of the seal.

Further objects and advantages of the invention will be apparent from the following description of the invention.

### SUMMARY OF THE INVENTION

In order to achieve the above-mentioned object, in a first embodiment of the metal gasket of the present invention which seals between a cylinder head and a cylinder block of engine, main sealing beads are provided along the circumference of a cylinder-bore hole. At the same time, meandering beads, wherein the main sealing beads meander, are provided only on portions, above which an inlet port of the cylinder head passes through and an exhaust port of the cylinder head passes through.

Alternatively, in a second embodiment of the metal gasket sealing between the cylinder head and cylinder block of the engine, the main sealing beads are provided along the circumference of the cylinder-bore hole. At the same time, meandering beads, wherein sub-beads meander, are provided partially in parallel on only the portions, above which the inlet port of the cylinder head passes through and the exhaust port of the cylinder head passes through, and outside the main sealing beads.

And, in a third embodiment of the above-mentioned metal gasket, ends of the meandering beads, wherein the sub-beads meander, are merged with the main sealing beads.

In the meandering beads, at least one of the height, width, or shape of cross section of the beads is formed differently from one of the main sealing beads.

According to the metal gasket of the present invention, the meandering beads can be designed to have increased length by virtue of the meandering shape, so that the surface pressure in the lengthened portions can be greatly increased.

Also, a measure of the sealing surface pressure of the lengthened portions can be also increased. Therefore, the lengthened portions are disposed only on the portions, where the engine sealing conditions are especially difficult, and where the inlet port and exhaust port of the cylinder head pass through.

As a result, any decrease in the surface pressure of the port portions, and any gas leak caused by the decrease in the surface pressure, can be prevented. Excellent sealing performance, therefore, can be achieved.

### BRIEF DESCRIPTION OF THE DRAWINGS

FIG. 1 is a plan view showing a metal gasket according to a first embodiment of the present invention;

FIG. 2 is a partial plan view showing the metal gasket according to the first embodiment of the present invention;

FIG. 3 is a plan view showing a metal gasket according to a second embodiment of the present invention;

FIG. 4 is a partial plan view showing the metal gasket according to the second embodiment of the present invention;

FIG. 5 is a plan view showing a metal gasket according to a third embodiment of the present invention; and

FIG. 6 is a partial plan view showing the metal gasket according to the third embodiment of the present invention.

### DETAILED DESCRIPTION OF THE PREFERRED EMBODIMENTS

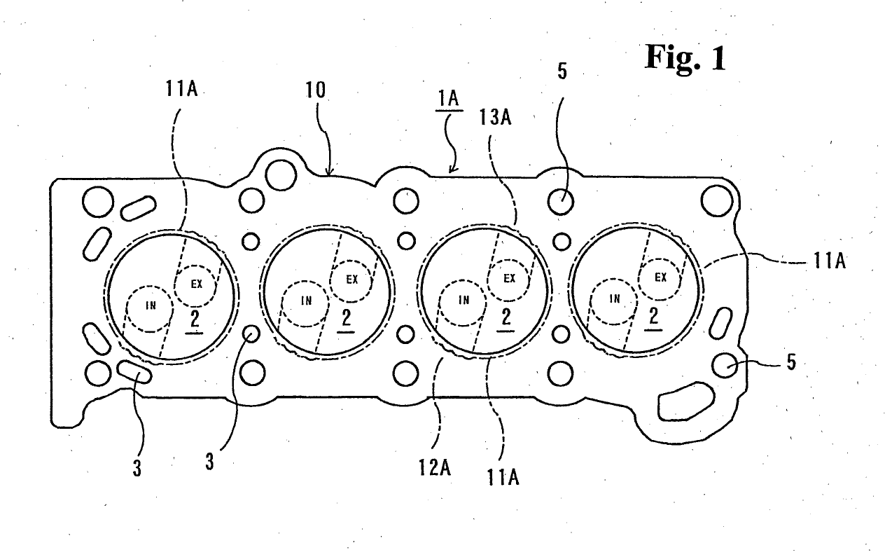

In the following description, embodiments of a metal gasket according to the present invention are explained with reference to the drawings. FIGS. 1-6 are explanatory-type drawings (i.e., not to scale), and structures are exaggeratingly shown by different sizes of cylinder bores, full beads, meandering beads, and so on that depart from actual sizes, so that the drawings of the structures are easily understood.

The metal gasket according to the present invention is a cylinder head gasket to be installed between-engine members of a cylinder head and the cylinder block (cylinder body) of an engine. The metal gasket seals high-temperature and high-pressure combustion gas in the cylinder bores, and seals fluids such as coolant water or oil and so on in coolant-water channels or coolant-oil channels.

As shown in FIGS. 1, 3, and 5, respectively, the metal gaskets 1A, 1B, and 1C include a metal substrate 10 formed of a mild steel plate, stainless-annealing material (anneal material), stainless-thermal refining material (spring-steel plate) and so on. Also, the metal gaskets 1A, 1B, 1C are prepared by fitting in shapes of the engine members such as the cylinder block and so on. The metal gaskets 1A, 1B, 1C, include cylinder-bore holes (combustion-chamber holes) 2, liquid holes 3 for circulating coolant water or engine oil, and head-bolt holes 5 for tightening a head bolt.

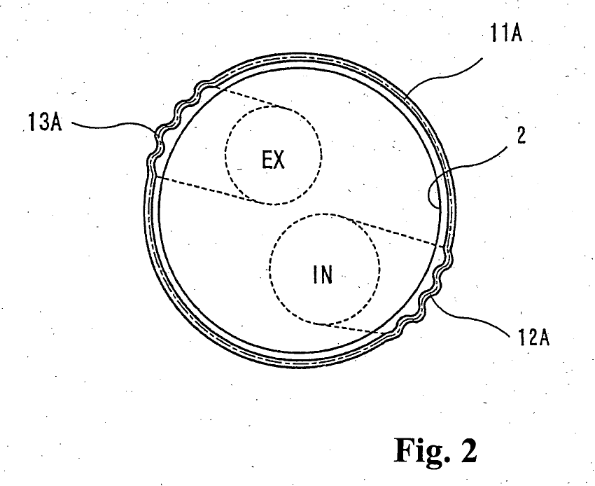

As shown in FIGS. 1 and 2, in a metal gasket 1A according to a first embodiment of the invention, main sealing beads 11A are provided along circumferences of the cylinder-bore holes 2 which are sealing-target holes. Also, meandering beads 12A, wherein the main sealing beads 11A meander, are provided on portions, above which inlet ports “IN” of the cylinder head pass through. Meandering beads 13A where the main sealing beads 11A meander are provided on portions, above which exhaust ports “EX” of the cylinder head pass through.

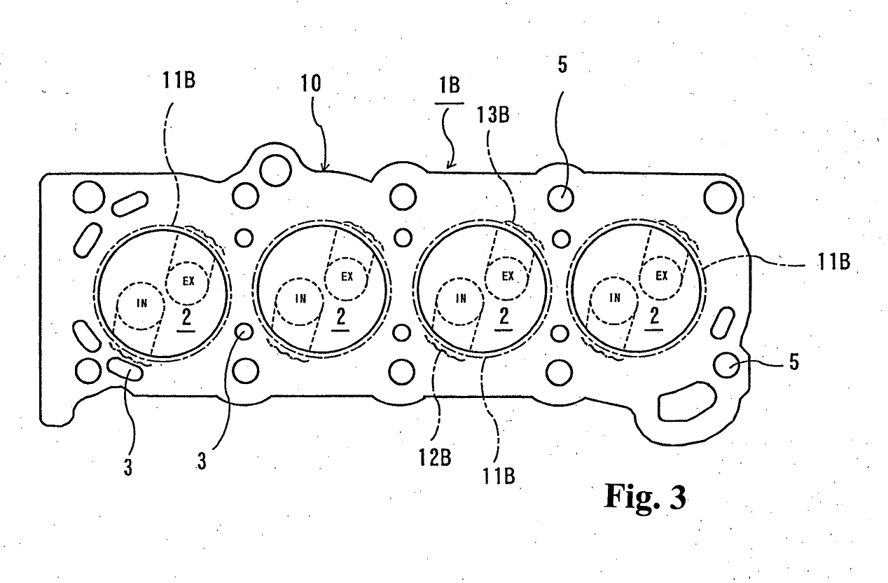

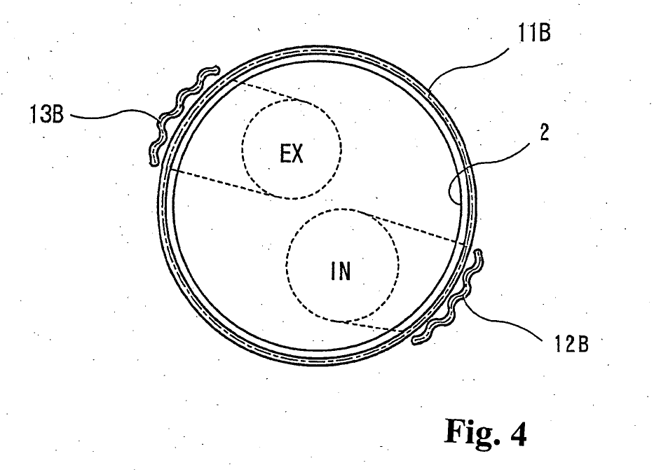

As shown in FIGS. 3 and 4, in a metal gasket 1B according to a second embodiment of the invention, main sealing beads 11B are provided along the circumferences of the cylinder-bore holes 2 which are the sealing-target holes. In addition, meandering beads 12B and 13B are provided partially in parallel on the portions, above which the inlet ports IN and the exhaust ports EX of the cylinder head pass through, and also outside the main sealing beads 11B, respectively.

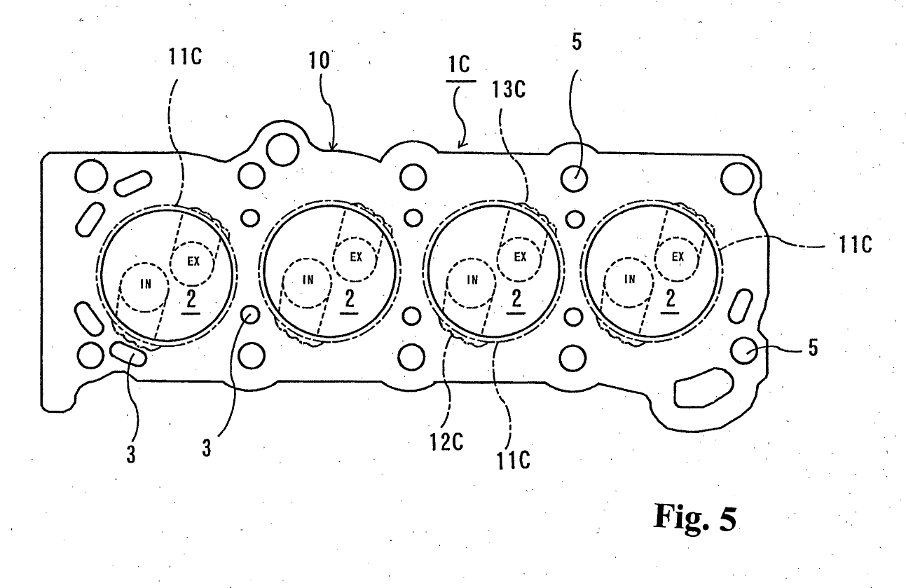

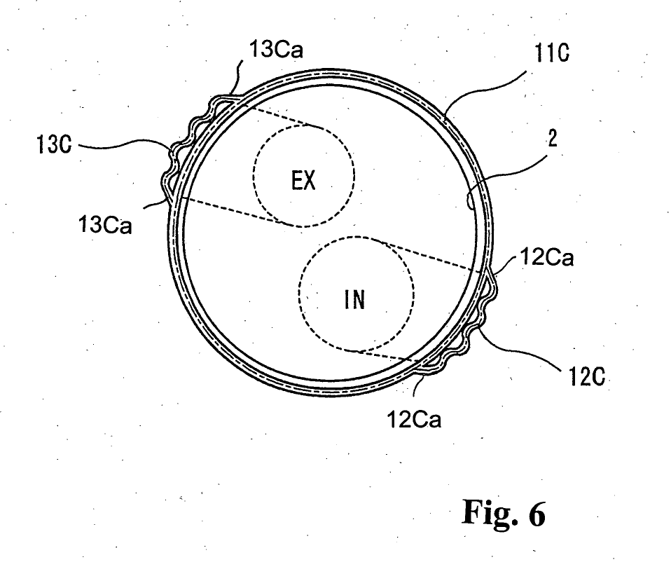

As shown in FIGS. 5 and 6, in a metal gasket 1C according to a third embodiment of the invention, main sealing beads 11C are provided along the circumferences of the cylinder-bore holes 2 which are the sealing-target holes, as well as the metal gasket 1B of the second. embodiment., In addition, meandering beads 12C and 13C are provided partially in parallel on the portions, above which the inlet ports IN and the exhaust ports EX of the cylinder head pass through, and also outside the main sealing beads 11C, respectively.

In the metal gasket 1C according to the third embodiment, the ends 12Ca, 13Ca of the meandering beads 12C, 13C are merged with the main sealing beads 11C. In a preferred embodiment, both ends of the meandering beads 12C, 13C and the main sealing beads 11C are merged. However, in still another embodiment of the invention, only one end of the meandering beads 12C, 13C may be merged with the main sealing beads 11C.

In the above-mentioned structure, the meandering beads may be formed in the same shape and size of the main sealing beads. However, at least one of the height, width, and shape of cross section of the meandering beads are formed differently from those of the main sealing beads, so that a more appropriate surface pressure distribution can be obtained. As a result, the structure can provide a better sealing performance.

According to the metal gaskets 1A, 1B, 1C, the meandering beads 12A, 13A, 12B, 13B, 12C, 13C can be designed to have increased length as result of the meandering shape, so that the surface pressure of these portions can be greatly increased. Also, a measure of the sealing surface pressure of the portions can be also increased. Therefore, a decrease in the surface pressure of the portions, above which the ability to seal the engine is especially difficult, and where the inlet ports and exhaust ports of the cylinder head pass through, can be prevented. As a result, excellent sealing performance can be achieved.

The disclosure of Japanese Pat. App. No. 2004-320399 filed on Nov. 4, 2004, is incorporated herein.

While the invention has be explained with reference to the specific embodiments of the invention, the explanation is illustrative, and the invention is limited only by the appended claims.

What is claimed is:

1. A metal gasket for an internal combustion engine having a cylinder head with inlet and exhaust portions, and a cylinder block with a cylinder bore, said gasket comprising:
at least one metal plate having a hole corresponding to the cylinder bore, at least one bead surrounding the hole for sealing the hole, at least one sealing area located under at least one of the inlet and exhaust portions, and at least one meandering bead located at the at least one sealing area to increase a surface pressure thereat when the gasket is tightened.

2. A metal gasket according to claim 1, wherein said at least one meandering bead is formed as a part of the at least one bead surrounding the hole.

3. A metal gasket according to claim 1, wherein said at least one meandering bead is formed outside the at least one bead relative to the hole in only the at least one sealing area.

4. A metal gasket according to claim 3, wherein said at least one meandering bead is formed separately from the at least one bead.

5. A metal gasket according to claim 4, wherein said at least one meandering bead includes end portions connected integrally with the at least one bead.

6. A metal gasket according to claim 1, wherein two sealing areas are formed on 'the at least one bead to face each other relative to the hole, and two meandering beads are formed in the two sealing areas.

7. A metal gasket according to claim 1, wherein said at least one meandering bead has a height, a width, and a cross-sectional shape, at least one of the height, width and cross-sectional shape being different from those of the at least one bead.
